(19) United States
(12) Patent Application Publication
(10) Pub. No.: US 2001/0027425 A1
(43) Pub. Date: Oct. 4, 2001

(54) Method of and apparatus for facilitating on-line transactions

(75) Inventor: Jeff Davies, Point Frederick (AU)

Correspondence Address: Intellectual Property Section, Law Department, NCR Corporation, 101 West Schantz, ECD-2, Dayton, OH, 45479-0001, US

(73) Assignee: NCR Corporation

(21) Appl. No.: 09/815,370

(22) Filed: Mar. 22, 2001

(30) Foreign Application Priority Data
Mar. 29, 2000 (GB) 0007671.1
May 5, 2000 (GB) 0010943.9

(51) Int. Cl. G06F 17/60

(52) U.S. Cl. 705/26

(57) ABSTRACT

A transaction network comprises a web-interface device, a web site and a communications device. The web-interface device and web site are adapted to enable a user to arrange an on-line agreement. The communications device is adapted to enables a user to authorise a payment associated with the agreement off-line.

### BACKGROUND OF THE INVENTION

The present invention relates to a method of and apparatus for facilitating on-line transactions, particularly on-line sales.

One of the biggest obstacles hindering the growth of on-line shopping today is the issue of credit card fraud. Whether this concern is justified given anti-fraud measures in place at present is secondary to the customer's perception that there is a problem. Additionally, some merchants also feel exposed by customers subsequently repudiating transactions that the merchant has executed correctly as per their offer to sell.

Visa™ International has announced that they have a “solution” to this problem in which they allow each Visacard™ user to have a second “dummy’ account with a lower fixed credit limit, (i.e. two account numbers on the same card). However, this approach does not solve the problem, it amounts to limiting a customer's potential financial exposure, rather than addressing the potential for fraud to occur. Consequently, the fact remains that few online shoppers feel comfortable with revealing their card details on the Internet. The Visa™ International idea also does nothing to protect the merchant.

Another approach to the problem is the use of encryption and other security features. These systems are exceedingly complex, and expensive to develop and administer. Even so, there is a perception, at least, that hackers improve as fast if not faster than security systems improve. Accordingly, members of the public, in general, at present do not have sufficient faith in these systems to entrust their financial details, such as credit card details, to the Internet.

### SUMMARY OF THE INVENTION

Accordingly, it is an object of the present invention to provide a method of and apparatus for facilitating on-line transactions, which addresses the aforementioned problem.

According to a first aspect of the present invention, there is provided a transaction network, comprising a web-interface device, a web site and a communications device, the web-interface device and web site being adapted to enable a user to arrange an on-line agreement, and the communications device being adapted to enable a user to authorise a payment associated with said agreement.

The communications device may, for example, be an Automatic Teller Machine (ATM), kiosk, or other self-service device.

The agreement is first arranged on-line via the web devices, and subsequently completed off-line by the authorisation of payment via the communications device, without revealing credit card or other financial account details to the merchant.

Thus the self-service terminal acts as a buyer authenticator protecting the user from fraudulent use of his or her financial accounts, and protects the merchant from repudiated or disputed transactions by the buyer, as a customer could not argue that he did not order goods or services when he has physically gone to a separate self-service device to finalise the transaction. This network also allows the user's financial institution to simultaneously authenticate the merchant as bone fide. Consequently, the network, in accordance with the present invention, utilises a trust relationship, which has grown over years of use between members of the public and financial institutions, which operate self-service terminal networks. This trust relationship is applied to the financial aspects of on-line commerce, where a trust relationship has not yet been established.

Preferably, the agreement concerns the supply of goods or services.

Preferably, the network comprises a first database, which is configured to store details of the agreement, including items to be purchased by the user and the agreed price, between the conclusion of the agreement and the authorisation of payment.

Preferably, details of the agreement are stored in the database under a transaction identification code, which is provided to the user, once the agreement is arranged, but before it has been completed by the authorisation of payment.

Preferably, the communications device enables a user to transmit financial details of an account to be debited with the payment to a second database.

Preferably, the user's financial details are stored in a second database.

Preferably, the financial details of the web-site operator required to enable a transfer of funds to the operator, in order to complete the transaction, are also transmitted to the second database, when in use.

Preferably, the web-interface is a web-enabled personal computer.

Alternatively, the web-interface is a web-enabled self-service terminal.

Preferably, the communications device is a telephone.

Preferably, the telephone is a GSM or other digital mobile telephone.

Alternatively, the communications device is a WAP enabled Personal Digital Assistant (PDA).

Alternatively, the communications device is a self-service terminal.

Preferably, the self-service terminal is part of a financial institution's network and is arranged to enable the user to transmit the aforementioned transaction identification code to a second database within the financial institution's network.

Preferably, the self-service terminal is an Automated Teller Machine.

Preferably, the self-service terminal is part of a financial institution's network and is arranged to enable the user to transmit the aforementioned code to a second database within the financial institution's network.

According to a second aspect of the present invention, there is provided a communications device adapted for use in a transaction network comprising a web-interface device and a web site, the web-interface device and web site being adapted to enable a user to arrange an on-line agreement, the communications device being adapted to enables a user to authorise a payment associated with said agreement.

Preferably, the device is arranged to enable a user to submit financial details of an account to be debited with the payment to a database.

Preferably, the device is in the form of a telephone.

More preferably the telephone is a GSM or other digital mobile telephone.

Alternatively, the device is in the form of a WAP enabled Personal Digital Assistant (PDA).

Alternatively, the device is in the form of a self-service terminal.

Preferably, the terminal is part of a financial institution's network and is arranged to enable the user to transmit the transaction identification code to said database within the financial institution's network.

More preferably, the terminal is an Automated Teller Machine.

According to a third aspect of the present invention there is provided a web-site adapted to enable a user to arrange an on-line sale, the site being arranged to present the user with a transaction identification code which can be used off-line in the process of authorising payment for said sale.

According to a fourth aspect of the present invention there is provided a web-interface adapted to enable a user to arrange an on-line sale, in association with a web-site, the web-interface being arranged to enable a user to input a request for off-line payment.

According to a fifth aspect of the present invention there is provided a method of performing a transaction, utilising a web-interface device, a web site and a communications device, wherein a user arranges an on-line agreement with a provider utilising the webinterface device and web site and authorises a payment associated with said agreement utilising the communications device.

Preferably, the agreement concerns the supply of goods or services.

Preferably, the details of the agreement are stored in a first database, including items to be purchased by the user and the agreed price, between the conclusion of the agreement and the authorisation of payment.

More preferably, the details of the agreement are stored in the database under a transaction identification code, which is provided to the user, once the agreement is arranged.

Preferably, the user inputs financial details of an account to be debited in association with the payment to a database, via said communications device.

Alternatively, the user's financial details are stored in a database.

Preferably, the financial details of the web-site operator required to enable a transfer of funds to the operator, in order to complete the transaction, are transmitted to said database.

Preferably, the communications device is a telephone.

More preferably, the telephone is a GSM or other digital mobile telephone.

Alternatively, the communications device is a WAP enabled Personal Digital Assistant (PDA).

Alternatively, the communications device is a self-service terminal.

Preferably, the self-service terminal is an Automated Teller Machine.

Preferably, the self-service terminal is part of a financial institution's network, and the user transmits the aforementioned code to a database within the financial institution's network.

According to a sixth aspect of the present invention there is provided a method of sales utilising a web-interface a web page and a self-service terminal, the method comprising the following steps:

(a) a user selects the goods/services to be purchased;

(b) a user then inputs a delivery address;

(c) the web page prompts for a means of payment;

(d) the user selects “offline” payment;

(e) an order for the selected good/services is stored in a database until the payment is authorised;

(f) the user is provided with a transaction identification code which identifies the order;

(g) the user utilises the self-service terminal and inserts the code, in response to a prompt therefor;

(h) the code is transferred to a second database which is part of a network operated by the financial institution which operates the self-service terminal;

(i) the financial institution then interrogates the first database for information on the order associated with the code, including financial details required to transfer funds to the provider of the goods or services, in order to complete the transaction;

(j) the financial institution then transfers funds to the provider's account from an account held by the buyer and chosen by him; and

(k) the order is processed and the goods or services supplied.

The whole process is carried out without the user's financial account details being disclosed outside of the financial institution's network.

According to a seventh aspect of the present invention there is provided a method of facilitating payment for a transaction, including the steps of:

a) issuing a user with a transaction identification code;

b) storing transaction information, under said code, including information required to enable a financial institution to pay for the transaction; and

c) the user transmitting the code to the financial institution, which thereafter obtains said information and instigates payment for the transaction.

Advantageously, the payment is executed between the user's financial institution and the merchant, or the merchant's representative, directly without disclosing any credit card or financial account information relating to the user. The financial institution debits the appropriate user account.

Preferably, the user is issued with at least some of said information, in order that the user may confirm a desire to proceed with the transaction.

Preferably, the data includes a list of the goods or services selected by the user for purchase.

Preferably, the transaction is an on-line transaction.

Preferably, the transaction identification code is issued by the on-line merchant.

Alternatively, the transaction identification code is issued by a third party.

Preferably, the user transmits the code to the financial institution via the Internet.

### BRIEF DESCRIPTION OF THE DRAWINGS

Embodiments of the present invention will now be described, by way of example, with reference to the accompanying drawings, in which:

FIG. 1 is a schematic representation of a sales network, in accordance with the present invention;

FIG. 2 is a schematic representation of a self-service terminal, in accordance with the present invention;

FIG. 3 is a representation of the user interface functions of the terminal of FIG. 2; and

FIG. 4 is a flow diagram of a method of selling goods or services, in accordance with the present invention.

### DETAILED DESCRIPTION

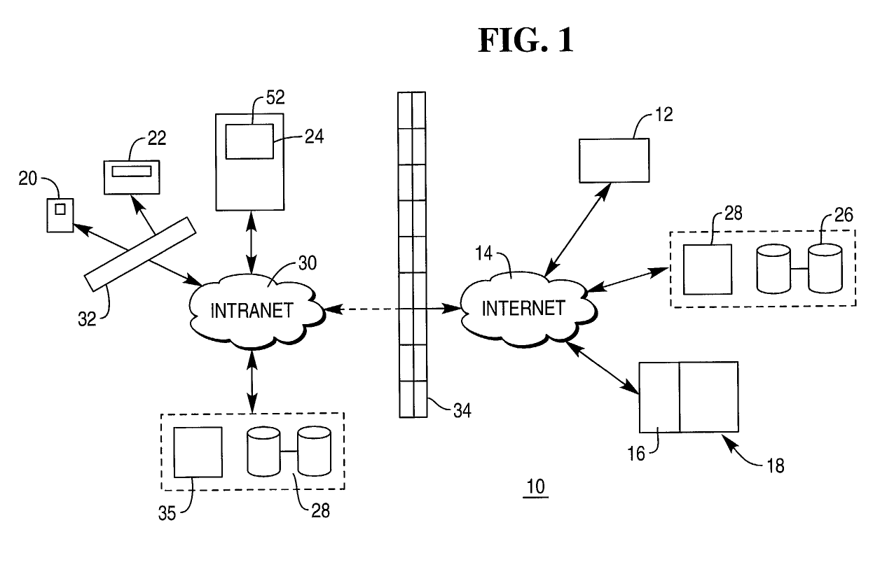

Referring to FIG. 1 there is illustrated a sales network 10, comprising a web-interface device in the form of a personal computer (PC) 12 that is configured for access to the Internet 14. The network 10 also includes a web site 16, which is stored on an Internet server 18 and a communications device. Three alternative communications devices are illustrated in FIG. 1, namely a GSM or other digital mobile telephone 20, a WAP enabled Personal Digital Assistant (PDA) 22 and a self-service terminal in the form of an Automated Teller Machine (ATM) 24.

The PC 12 and web site 16 are adapted to enable a user to arrange an on-line agreement and each of the communications devices 20, 22 & 24 are adapted to enable a user to authorise a payment associated with said agreement, as will be described below.

The web site 16 has been set-up for the sale of books on-line, although the network and method, in accordance with the present invention will operate for the sale, or lease or provision of any goods or services.

The network further includes a first database 26, which is configured to store details of each agreement, including items to be purchased by the user. The database 26 stores these details between the conclusion of the agreement and the authorisation of payment. The database 26 may be a Teradata™ database as supplied by NCR Corporation of Dayton, Ohio. The operation of the database 26 is controlled via a CPU 28. The details of each agreement are stored in the database 26 under a transaction identification code, which is provided to the user, once the agreement is arranged. The code is either e-mailed to the user or is displayed on the web page during the transaction. The code itself might for example, be a 16 digit numerical code. The code may be determined by the operator of the web site 16 and need not be randomly generated, as it is not required to be particularly secure. All the code uniquely identifies is a particular transaction within a database and does not allow anyone access to financial information relating to the user. Therefore it has absolutely no value to anyone stealing it or using it in an authorised manner.

This code can be issued either by the merchant selling the books, or by some central agency. In the latter case the merchant's identity must form part of the code, along with the transaction identification. In the former case the code need only identify the actual transaction which when referenced to the database automatically identifies the merchant, along with other pertinent details of the proposed transaction.

Each of the communications devices 20, 22 & 24 enables a user to transmit financial details of an account to be debited with the payment to a second database 28. Alternatively, user's financial details may be stored in the second database 28. The second database 28 is part of the secure communications network of a financial institution and is connected to each of the communication devices through an Intranet 30. In the case of the ATM 24 the connection may be a direct connection, as the ATM is part of the financial institutions network. In the case of the PDA 22 and mobile phone 20, because they are not connected to the Intranet 30 directly access is through an appropriate communications gateway 32, as with normal GSM or WAP device interaction with a TCP/IP network.

As will be seen below, the financial details of the web-site operator, required to enable a transfer of funds to the operator, in order to complete the transaction, are also transmitted to the second database, when in use. This transaction may be direct from the database 26 to the database 28, through the Internet, via a Firewall 34.

Alternatively, the merchant's financial details may be stored in a third database (not shown) perhaps at the merchant's bank (not shown). These details may also be transmitted to the database 28 via the Internet or some other appropriate telecommunications system.

In another embodiment of the present invention the web-interface may be one of the communications devices, which is itself web enabled.

Like the database 26, the database 28 also has a CPU 35.

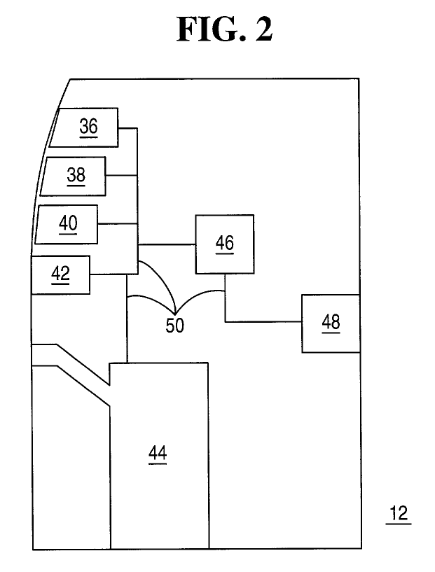

FIG. 2 shows an ATM 12 of FIG. 1 in more detail. The ATM 24 includes a display module 36 and encrypting keypad module 38, a magnetic card reader/writer (MCRW) module 40, a receipt printer 42, a cash dispenser module 44, an ATM central processor (CPU) module 46 for controlling the operations of various modules and a network connection module 48 for communication with the Intranet 30. A proprietary internal bus 52 interconnects all of the modules within the ATM 24. The magnetic card reader/writer module 40 forms part of a means for verifying a user's authorisation and display module 36 includes a display 58 for the presentation of information to users.

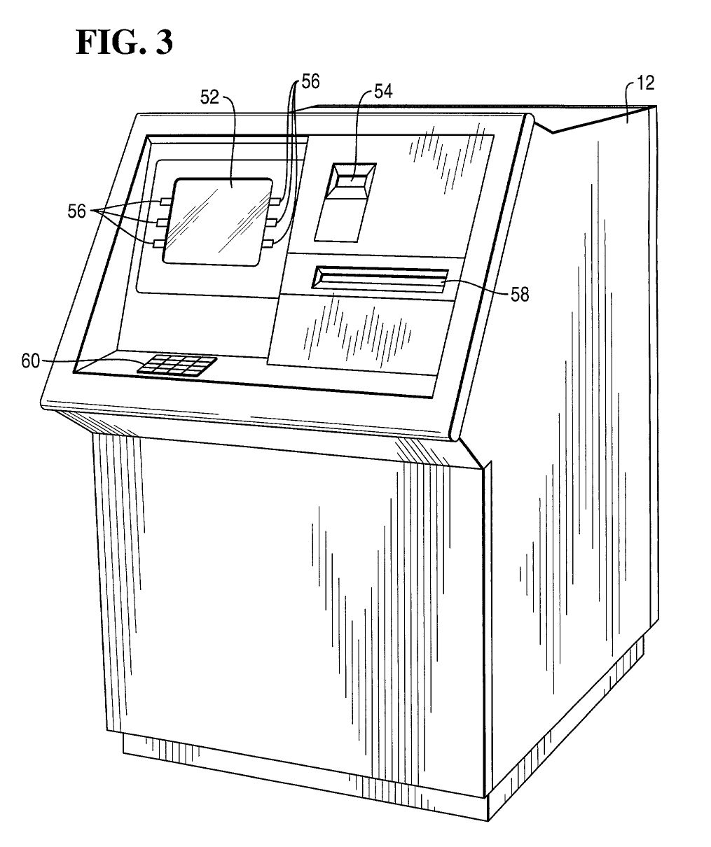

FIG. 3 illustrates the user interface of an ATM 12 in accordance with the present invention. The ATM 12 is a standard ATM with a display 58, including Function Display Keys, (FDK's) 56, a card receiving slot 54, a cash dispensing slot 60 and an encrypting key pad 62.

The self-service terminal 24 of FIGS. 2 and 3 is adapted for use in the sales network 10, described above. The ATM 24 enables a user to authorise a payment associated with said agreement. The display 58 indicates both “financial services” and “transaction authorisation” as options when a user inputs a card into the card receiving slot 54 (FIG. 3). In some embodiments a user may not even be required to enter a card or other form of identification. The service option may be indicated above at the very beginning of the transaction and a user may be able to either deposit cash or a cheque to the value of the payment required or may be able to identify an account to be debited, which may or may not be held at the financial institution mentioned above. Selection of services and input of the transaction identification code is carried out using the FDK's 56 and the encrypted keypad 62.

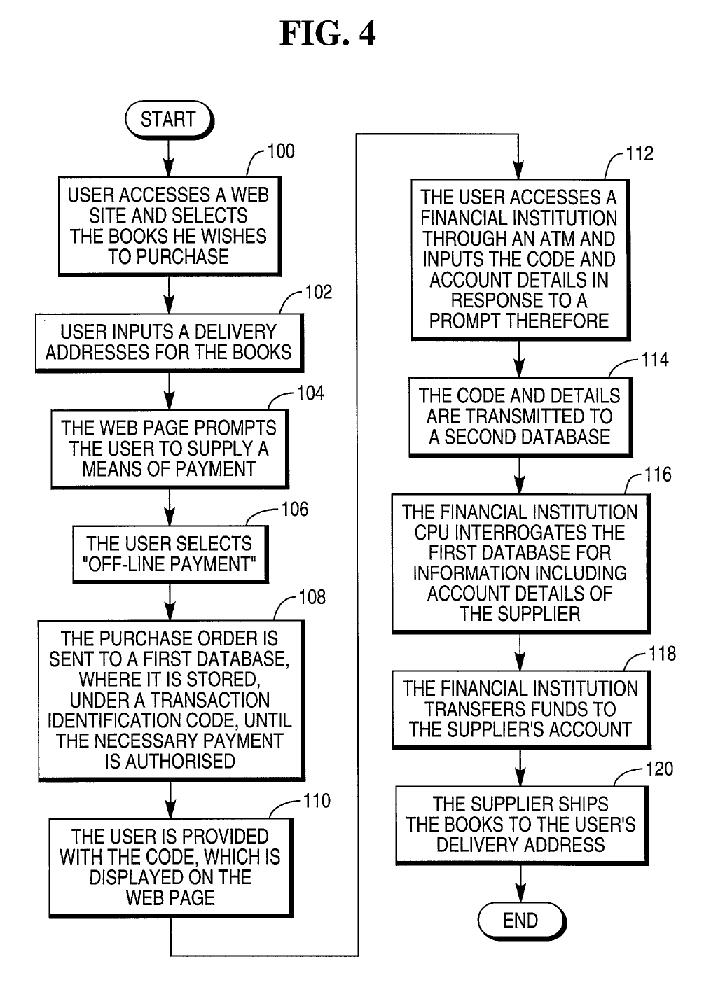

FIG. 4 illustrates the use of a network in accordance with the present invention, by a user who wishes to purchase goods through the Internet.

In accordance with the method, a user selects the goods/services to be purchased using a web interface in the form of a personal computer 12 [box 100]. A user then inputs a delivery address into the PC 12 [box 102].

The web page then prompts for the user to indicate a means of payment [box 104] and the user selects “offline” payment [box 106].

An order for the books selected by the user is then stored in a database 26 until the payment is authorised [box 108] and the user is provided with a transaction identification code which identifies the order [box 110].

The user then utilises one of the communications devices, in this case the self-service terminal 24, and inserts the transaction identification code, in response to a prompt therefor [box 112]. The ATM 24 transfers the code to a second database 28 which is part of the network 30 operated by the financial institution which operates the ATM 24 [box 114].

The financial institution then interrogates the first database 26 for information on the order associated with the code, including financial details required to transfer funds to the provider of the books, in order to complete the transaction [box 116]. The financial institution then transfers funds to the provider's account [box 118], from an account held by the buyer and chosen by him, whereupon, the order is processed and the books are shipped to the user's supply address [box 120].

The agreement is arranged on-line without the user being required to reveal credit card or other financial account details to the merchant.

An important aspect of the present invention is the concept of a reverse token exchange, wherein the transaction identification code is the token. The token is produced not by the user, as in prior art procedures wherein the token is the user's credit card details. The code is produced, in this embodiment, by the web site controller, although it could be readily produced by a third party. This code enables a user to identify a transaction and to reference that transaction off-line, as discussed above. Thus if the code is stolen all the thief obtains is a “Shopping List” and not a means of access to a user's credit, as with the prior art.

Accordingly, from another aspect the present invention may be seen as a method of facilitating payment for a transaction. The method includes issuing a user with a transaction identification code. The on-line merchant issues the transaction identification code, although, as in the previous embodiment, a third party may issue the code.

The method also includes storing transaction information, under said code, including information required to enable a financial institution to pay for the transaction. The data includes a list of the goods or services selected by the user for purchase. The user is issued with at least some of said information, in order that he or she may confirm a desire to proceed with the transaction.

The method also includes the user transmitting the code to the financial institution, which thereafter obtains said information and instigates payment for the transaction. The user transmits the code to the financial institution via the Internet.

Advantageously, the payment, in this method, is executed between the user's financial institution and the merchant, or the merchant's representative, directly without disclosing any credit card or financial account information relating to the user. The financial institution debits the appropriate user account.

The method described above maybe carried out utilising the apparatus described with reference to FIGS. 1 to 3.

Modifications may be incorporated without departing from the scope of the present invention.

What is claimed is:

1. A sales network comprising:
a web site;
a web-interface device for cooperating with the web site to enable a user to arrange an on-line agreement; and
a communications device for enabling a user to authorise a payment associated with the agreement.

2. A network as claimed in claim 1, wherein the agreement concerns the supply of goods or services.

3. A network as claimed in claim 2, wherein the network comprises a first database, which is configured to store details of the agreement, including items to be purchased by the user, between the conclusion of the agreement and the authorisation of payment.

4. A network as claimed in claim 3, wherein details of the agreement are stored in the first database under a transaction identification code, which is provided to the user, once the agreement is arranged.

5. A network as claimed in claim 1, wherein the communications device includes means for enabling a user to transmit financial details of an account to be debited with the payment to a second database.

6. A network as claimed in claim 4, wherein the user's financial details are stored in a second database.

7. A network as claimed in claim 6, wherein the financial details of the web-site operator required to enable a transfer of funds to the operator, in order to complete the transaction, are also transmitted to the second database, when in use.

8. A network as claimed in claim 1, wherein the web-interface comprises a web-enabled personal computer.

9. A network as claimed in claim 1, wherein the web-interface comprises a web-enabled self-service terminal.

10. A network as claimed in claim 1, wherein the communications device comprises a telephone.

11. A network a claimed in claim 10, wherein the telephone includes a GSM or other digital mobile telephone.

12. A network as claimed in claim 1, wherein the communications device comprises a WAP enabled Personal Digital Assistant (PDA).

13. A network as claimed in claim 1, wherein the communications device comprises a self-service terminal.

14. A network as claimed in claim 13, wherein the self-service terminal is part of a financial institution's network and is arranged to enable the user to transmit the aforementioned code to a second database within the financial institution's network.

15. A network as claimed in claim 13, wherein the self-service terminal includes an Automated Teller Machine.

16. A communications device adapted for use in a sales network having a web site and a web-interface device which enable a user to arrange an on-line agreement, the communications device comprising:
means for enabling a user to authorise a payment associated with the agreement.

17. A device as claimed in claim 16, further comprising means for enabling a user to submit financial details of an account to be debited with the payment to a database.

18. A device as claimed in claim 16, wherein the device is in the form of a telephone.

19. A device as claimed in claim 18, wherein the telephone is in the form of a GSM or other digital mobile telephone.

20. A device as claimed in claim 16, wherein the device is in the form of a WAP enabled Personal Digital Assistant (PDA).

21. A device as claimed in claim 16, wherein the device is in the form of a self-service terminal.

22. A device as claimed in claim 21, wherein the terminal is part of a financial institution's network and is arranged to enable the user to transmit the transaction identification code to a database within the financial institution's network.

23. A device as claimed in claim 21, wherein the self-service terminal is in the form of an Automated Teller machine.

24. A web-site for enabling a user to arrange an on-line sale, the site comprising:
means for presenting the user with a code which can be used off-line in the process of authorising payment for the sale.

25. A web-interface for enabling a user to arrange an on-line sale, in association with a web-site, the web-interface comprising:
means for enabling a user to input a request for off-line payment.

26. A method of sales to a user, utilising a web-interface device, a web site and a communications device, the method comprising:
arranging an on-line agreement with a provider utilising the web-interface device and web site; and
authorising a payment associated with the agreement utilising the communications device.

27. A method as claimed in claim 26, wherein the agreement concerns the supply of goods or services.

28. A method as claimed in claim 27, further comprising storing details of the agreement in a first database, including items to be purchased by the user, between the conclusion of the agreement and the authorisation of payment.

29. A method as claimed in claim 28, further comprising storing details of the agreement in the first database under a transaction identification code, which is provided to the user, once the agreement is arranged.

30. A method as claimed in claim 26, further comprising receiving from the user financial details of an account to be debited in association with the payment to a database, via the communications device.

31. A method as claimed in claim 29, further comprising storing the user's financial details in a second database.

32. A method as claimed in claim 31, further comprising transmitting to the second database the financial details of the web-site operator required to enable a transfer of funds to the operator, in order to complete the transaction.

33. A method as claimed in claim 26, wherein the communications device comprises a telephone.

34. A method as claimed in claim 33, wherein the telephone includes a GSM or other digital mobile telephone.

35. A method as claimed in claims 26, wherein the communications device comprises a WAP enabled Personal Digital Assistant (PDA).

36. A method as claimed in claim 26, wherein the communications device comprises a self-service terminal.

37. A method as claimed in claim 36, wherein the self-service terminal includes an Automated Teller Machine.

38. A method as claimed in claim 36, wherein the self-service terminal is part of a financial institution's network, and further comprising transmitting the aforementioned code to a database within the financial institution's network.

39. A method of sales utilizing a web-interface, a web page, and a self-service terminal, the method comprising the steps of:
(a) a user selects the goods/services to be purchased;
(b) a user then inputs a delivery address;
(c) the web page prompts for a means of payment;
(d) the user selects “offline” payment
(e) an order for the selected good/services is stored in a first database until the payment is authorised;
(f) the user is provided with a code which identifies the order;
(g) the user utilises the self-service terminal and inserts the code, in response to a prompt therefor;
(h) the code is transferred to a second database which is part of a network operated by the financial institution which operates the self-service terminal;
(i) the financial institution then interrogates the first database for information on the order associated with the code, including financial details required to transfer funds to the provider of the goods or services, in order to complete the transaction;
(j) the financial institution then transfers funds to the provider's account from an account held by the buyer and chosen by him; and
(k) the order is processed and the goods or services supplied.

40. A method of facilitating payment for a transaction, the method comprising the steps of:
(a) issuing a user with a transaction identification code;
(b) storing transaction information, under the code, including information required to enable a financial institution to pay for the transaction; and
(c) the user transmitting the code to the financial institution, which thereafter obtains the information and instigates payment for the transaction.

41. A method as claimed in claim 40, wherein the user is issued with at least some of the information, in order that the user may confirm a desire to proceed with the transaction.

42. A method as claimed in claim 40, wherein the data includes a list of the goods or services selected by the user for purchase.

43. A method as claimed in claim 40, wherein the transaction is an on-line transaction.

44. A method as claimed in claim 43, wherein the transaction identification code is issued by the on-line merchant.

45. A method as claimed in claim 43, wherein the transaction identification code is issued by a third party.

46. A method as claimed in claim 40, wherein the user transmits the code to the financial institution via the Internet.

47. A method as claimed in claim 40, wherein the user utilises a communications device to transmit the code to the financial institution.

48. A method as claimed in claim 47, wherein the communications device is used to transmit financial details of an account to be debited with the payment to the financial institution.

49. A network as claimed in claim 40, wherein the user's financial details are stored in a second database.

50. A network as claimed in claim 49, wherein the financial details of the web-site operator required to enable a transfer of funds to the merchant, in order to complete the transaction, are also transmitted to the second database, when in use.

51. A network as claimed in claim 40, wherein the web-interface comprises a web-enabled personal computer.

52. A network as claimed in claim 40, wherein the web-interface comprises a web-enabled self-service terminal.

53. A network as claimed in claim 47, wherein the communications device comprises a telephone.

54. A network as claimed in claim 47, wherein the communications device comprises a WAP enabled Personal Digital Assistant (PDA).

55. A network as claimed in claim 47, wherein the communications device comprises a self-service terminal.

56. A network as claimed in claim 55, wherein the self-service terminal is part of a financial institution's network and is arranged to enable the user to transmit the aforementioned code to a second database within the financial institution's network.

57. A network as claimed in claim 55, wherein the self-service terminal includes an Automated Teller Machine.
